(19) United States
(12) Patent Application Publication
(10) Pub. No.: US 2020/0321730 A1
(43) Pub. Date: Oct. 8, 2020

(54) SMALL FORM FACTOR CONNECTION MECHANISM FOR A CARD TO CARD CONNECTOR

(71) Applicant: Intel Corporation, Santa Clara, CA (US)

(72) Inventor: Wesley B. MORGAN, Olympia, WA (US)

(21) Appl. No.: 16/906,924

(22) Filed: Jun. 19, 2020

Related U.S. Application Data
(60) Provisional application No. 62/865,056, filed on Jun. 21, 2019.

(51) Int. Cl. H01R 13/629; F16C 11/04

(52) U.S. Cl. CPC H01R 13/62938; H01R 12/7082; F16C 11/04

(57) ABSTRACT

An apparatus is described. The apparatus includes a hinge assembly. The hinge assembly includes: i) a stationary element, a first hole formed in the stationary element to receive a retaining screw; ii) a rotating element that rotates around the retaining screw's axis; and iii) an isolation element between the stationary element and the rotating element located along the retaining screw's axis. The isolation element has a second hole that is aligned with the first hole to receive the retaining screw. The rotating element is to be in contact with and rotate about the isolation element when the retaining screw is torqued down to clamp the isolation element and stationary element together.

### RELATED CASES

This application claims the benefit of U.S. Provisional Application No. 62/865,056, entitled, “SMALL FORM FACTOR CONNECTION MECHANISM FOR A CARD TO CARD CONNECTOR”, filed Jun. 21, 2019, which is incorporated by reference in its entirety.

### FIELD OF INVENTION

The field of invention pertains generally to the mechanical arts, and, more specifically, to a small form factor connection mechanism for a card to card connector.

### BACKGROUND

With ever increasing signal speeds and wiring densities in high performance computing and/or networking systems, system designers are constantly seeking ways to reliably route more and more signals in tight/small form factor solutions.

### FIGURES

A better understanding of the present invention can be obtained from the following detailed description in conjunction with the following drawings, in which:

FIG. 1a shows cards plugged into a backplane;

FIG. 1b shows cards connected by a card-to-card connector;

FIG. 2a depicts a pair of cards;

FIG. 2b depicts a connection mechanism for a card to card connector;

FIGS. 3a and 3b shows a more detailed depiction of a pair of cards connected by a card to card connector;

FIG. 4 shows a first view of an embodiment of a card to card connector connection mechanism;

FIG. 5 shows a second view of an embodiment of a card to card connector connection mechanism;

FIG. 6 shows a third view of an embodiment of a card to card connector connection mechanism;

FIG. 7a shows a washer for use in the connection mechanism of FIGS. 4, 5 and 6;

FIGS. 7b and 7c show alternative connection mechanism designs;

FIG. 8 pertains to manufacture of the washer of FIG. 7;

FIG. 9a shows a computing system;

FIG. 9b shows a networking switch/router;

FIG. 10 shows a data center.

### DETAILED DESCRIPTION

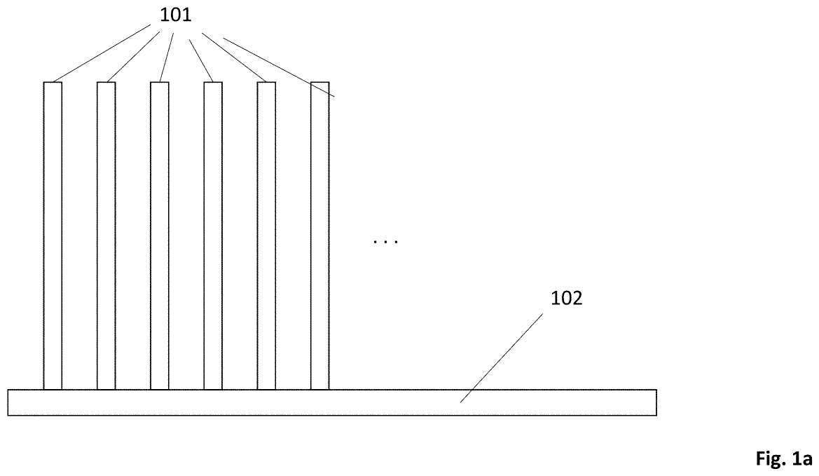

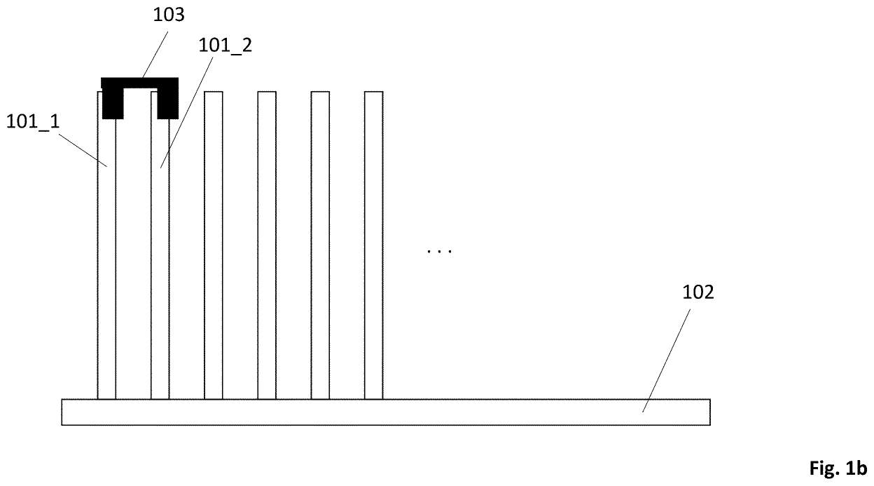

Referring to FIG. 1a, electronic cards 101 (also referred to as “boards”) having semiconductor chips, firmware, etc. designed to perform some function are plugged into a backplane 102 of an electronic system. The backplane 102 provides card to card interconnects so that information from one card can be sent to another card.

The backplane approach, however, can have limitations particularly in the case of very high speed card to card signals and/or large numbers of card to card signals that, e.g., commonly exist in data centers. Generally, high speed signals should be kept as short as possible, and, backplane card to card connections can result in extended wiring trace lengths over the cards and/or backplane. In the case of large numbers of card to card signals it becomes difficult to route all such signals over a single backplane 102.

Dis-aggregated computer system (e.g., dis-aggregated server) implementations are also being undertaken. In the case of a dis-aggregated computer system, unlike a traditional computer in which the core components of a computing system (e.g., CPU processors, memory, storage, accelerators, etc.) are all housed within a common chassis and connected to a common motherboard, such components are instead integrated on separate pluggable cards or other pluggable components (e.g., a CPU card, a system memory card, a storage card, an accelerator card, etc.) that plug-into a larger exposed backplane or network instead of a same, confined motherboard. As such, for instance, CPU computer power can be added by adding CPU cards to the backplane or network, system memory can be added by adding memory cards to the backplane or network, etc. Such systems can exhibit even more high speed card to card connections that traditional computers. One or more dis-aggregated computers and/or traditional computers/servers can be identified as a Point of Delivery (PoD) for computing system function in, e.g., the larger configuration of an information technology (IT) implementation such as a data center.

High performance server computers and/or networking systems, such as the kinds of computers and networking systems found in data centers, tend to be composed of large numbers of high speed signals. Examples of such high speed signals include, e.g., data and/or clocking signals associated with any of Infinity Fabric (e.g., as associated and/or implemented with AMD products) or derivatives thereof, specifications developed by the Cache Coherent Interconnect for Accelerators (CCIX) consortium or derivatives thereof, specifications developed by the GEN-Z consortium or derivatives thereof, specifications developed by the Coherent Accelerator Processor Interface (CAPI) or derivatives thereof, specifications developed by the Compute Express Link (CXL) consortium or derivatives thereof, specifications developed by the Hyper Transport consortium or derivative thereof, Ethernet, Infiniband, NVMe-oF, PCIe, etc. Again, in the case of large numbers of card to card signals it becomes difficult to route all such signals over a single backplane 102 or through a network. Such systems therefore tend to suffer from backplane/network induced limitations more than other types of systems.

Dedicated “card to card” connectors can help alleviate both of these problems. A card to card connector 103 is depicted in FIG. 1b. Here, rather than route certain signals between neighboring cards 101_1, 101_2 over the backplane 102, instead, such signals are routed over a special connector 103 that is connected to both cards. As observed in the particular embodiment of FIG. 1b, the card to card connector 103 is connected to the respective top sides of the cards 101_1, 101_2 while the respective bottom sides of the cards plug into backplane 103.

With the card to card connector 103 it is easier to route high speed signals between the cards 101_1, 101_2 with shorter wiring trace lengths and/or route larger numbers of signals between the cards 101_1, 101_2 (the presence of the card to card connector 103 provides excess signal wiring capacity that eases the signal count on the backplane 102). As such, high speed computing systems and/or networking switches/routers, e.g., for use in a data center, may make use of card to card connectors such as any of the card to card connector embodiments described immediately below.

Moreover, for cards that physically connect to the system (e.g., via a backplane) according to an industry standard specification (e.g., Peripheral Component Interconnect express (PCIe), the industry standard connection may be deficient in various ways (e.g., speed, number of pin-outs, etc.) to fully support the types/kinds of communications between cards that system designers envision. Card to card connectors therefore can allow inter-card communications as envisioned by system designers while maintaining full industry standard compliance with respect to card to system interconnect.

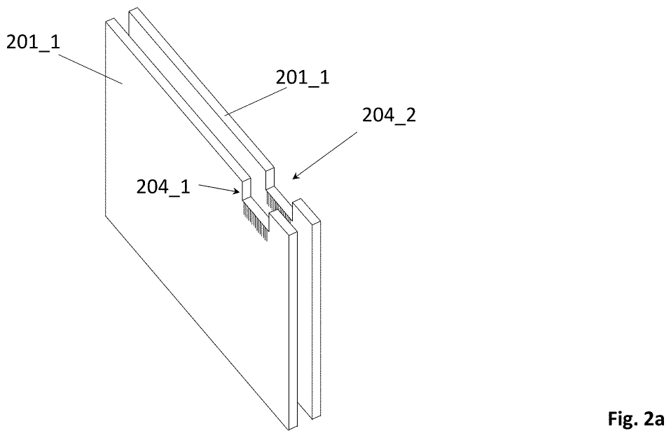

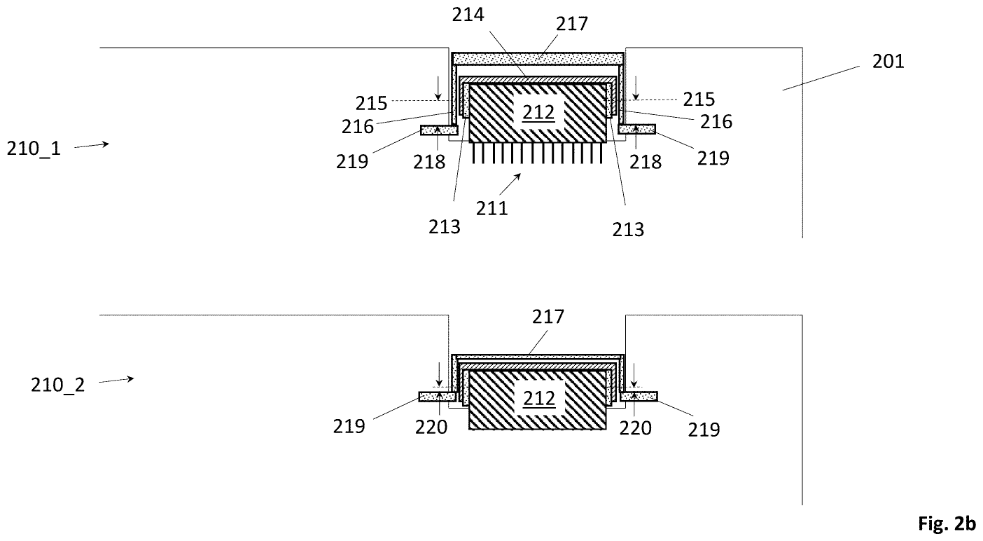

FIGS. 2a and 2b provide more details on a particular card to card connector implementation. FIG. 2a shows two cards 201_1, 201_2 as they would be oriented when plugged into a common backplane. Here, each card includes a cut out 204_1, 204_2 where a card-to-card connector is to connect with each card.

FIG. 2b shows a high level view of an embodiment of the connection mechanism by which a card to card connector actually connects to a card in the cut out region. Here, referring to inset 210_1, the bottom side of the cut-out region of the card includes conductive traces 211 that mate with an edge connector 212. In various embodiments the conductive traces 211 may be on both sides of the card 201 so that the edge connector 212 makes electrical connections on both card sides, or, the conductive traces 211 are only on one side of the card 201 so that the edge connector 212 makes electrical connections on only one card side.

The edge connector 212 is affixed on both sides by a respective brace element 213. A cover element 214 covers the top side of the edge connector 212 and connects to both brace elements 213 at the sides of the edge connector 212. In an embodiment, the attachment of the brace elements 213 to the cover element 214 is effected with respective screws (not shown for illustrative ease).

Specifically, on each side of the cover element 214, a screw is oriented along axis 215 and threads into the brace element 213. The head of the screw fits into the hole of a protrusion (counterbore) that is formed on the side of the cover element 214 and extends outward along axis 215. For ease of drawing, neither the screws nor the protrusions are depicted in FIG. 2b. They are depicted, however, in more detailed drawings that are discussed further below.

A set of cam-levers 216 and a handle 217 are formed from a single element that rotates about the aforementioned protrusion around axis 215. Inset 210_1 of FIG. 2b shows a first position of the connection mechanism when the handle 217 is “up” and the cam-levers 216 are oriented such that their extended length 218 is pressing down on respective support fixtures 219 that are mounted to the card 201. The extended length 218 of the cam-levers 216 pressing down on the support fixtures 219 causes the edge connector 212 to rise so that its edge connections are not in firm contact with the cards edge connections 211.

As such, the position of inset 210_1 of FIG. 2a corresponds to the position of the connection mechanism when the connector is first being placed in contact with the card 201 for connection with the card, 201 or, after the handle 217 has been lifted to remove the connector from the card 201.

Inset 210_2 of FIG. 2b shows a second position of the connection mechanism when the handle 217 has been “closed” by rotating the cam levers 216 and handle element 217 about axis 215. As the cam-levers 216 rotate along support fixture 219, their length reduces to a shortened length 220 which physically lowers the axis of rotation 215 and the edge connector 212. The lowering of the edge connector 212 causes its edge connections to slide over the card's edge connections 211 resulting in electrical-mechanical connection between the edge connector 212 and the card 201.

For simplicity the wiring that emerges out of the edge connector and connects to the edge connector that is to be connected to the other card is not shown in FIG. 2b. However, in various embodiments such wiring resides beneath the cover element 214.

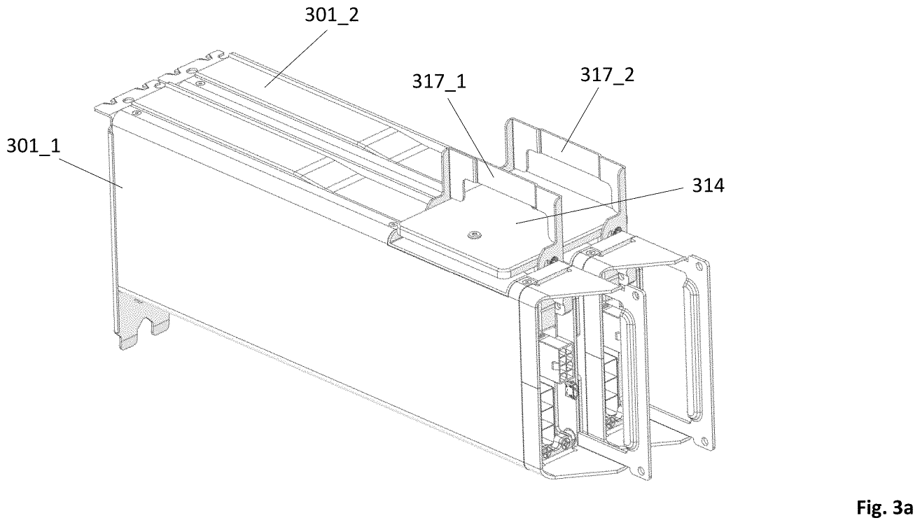

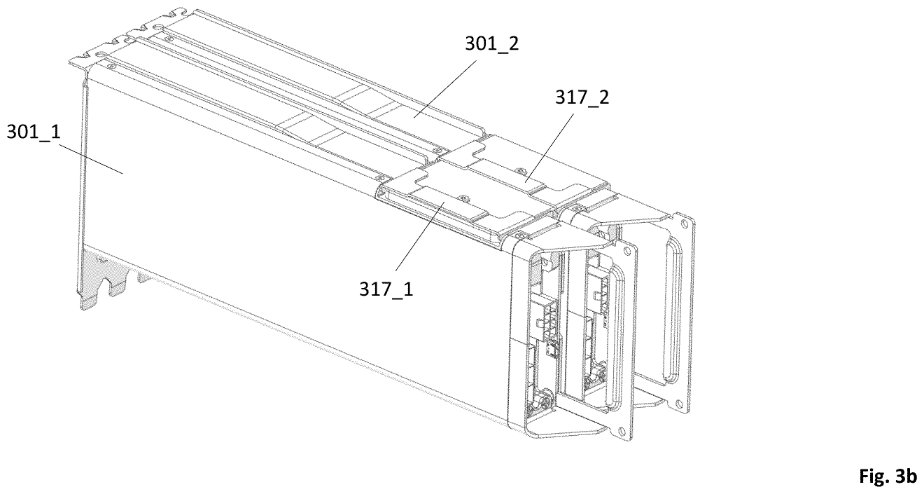

FIGS. 3a and 3b show more detail drawings of the card to card connector 303 making connection to a pair of cards 301_1, 301_2 (the cards as depicted are covered by respective covers to, e.g., concentrate cooling air flow over their respective semiconductor chips and/or protect against EMI noise).

Here, FIG. 3a shows the first connection mechanism position in which the respective handles 317_1, 317_2 for both edge connectors are in a raised position (the positioning of FIG.

3a therefore corresponds to the positioning of FIG. 2a). Note that the cover element 314 is in a raised position. Correspondingly, beneath the cover element 314, the edge connectors are raised above their respective card's edge connections.

FIG. 3b shows the second position in which the respective handles 317_1, 317_2 have been rotated into a closed position (the positioning of FIG. 3b therefore corresponds to the positioning of FIG. 2b). Notably, the rotation has caused the cover element 314 to lower toward the cards. Corresponding, in this position, both edge connectors have lowered onto their respective card's edge connections thereby making full electrical-mechanical contact with their respective cards.

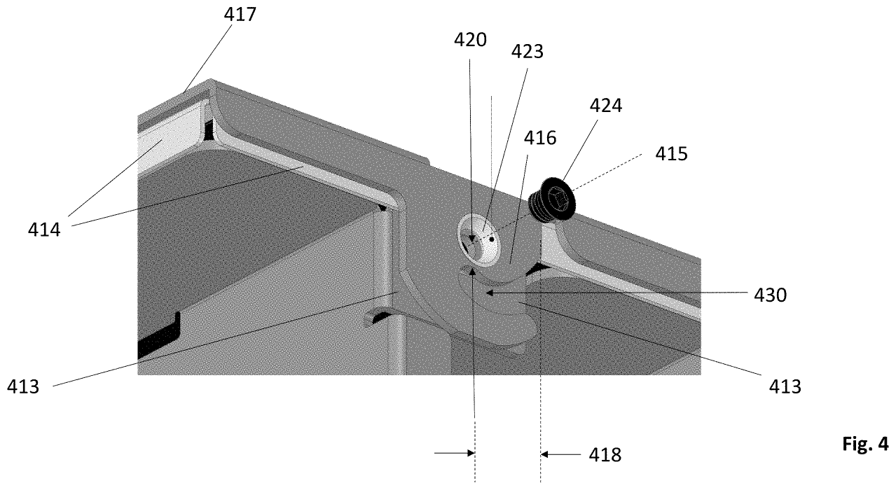

FIG. 4 shows a more detailed side view of the brace element 413, cover element 414, cam lever 416 and handle 417. As depicted, the rotation of the cam lever 416 and handle 417 are such that the handle is in the closed position akin to FIGS. 2b and 3b discussed above. Here, support fixture 219 of FIG. 2b is implemented as a cylindrical post or pin that fits into opening 430. As such, physical distance 420 corresponds to the shortened length 220 of the cam lever 216 of FIG. 2b. As can be envisioned, if the handle element 417 is “lifted” so as to cause rotation in a clockwise direction, when the handle 417 is in a fully upright position, the cam lever 416 will be pressing against the post in its extended length position which corresponds to physical distance 418.

FIG. 4 also shows the aforementioned protrusion 423 that extends from the cover element 415 and screw 424. For ease of drawing an exploded view is shown in which the screw 424 is positioned along the aforementioned axis 415. As can be seen, the protrusion 423 is an element of the cover element 414 that extends outward from side of the cover element 414 along axis 415. As described above, the threads of the screw 424 screw into threads formed in the brace element 413 “behind” the protrusion 423. When fully threaded into these threads, the head of the screw 424 sits in the opening of the protrusion 423. The face of the protrusion that faces the screw is countersunk so that the screw head fits within the protrusion. Notably, as will become more clear in the following discussion, the cover element 414 with protrusion 423 acts as an interface element to allow the screw to be torqued down to complete the connector assembly while allowing a rotating element (e.g., the handle) to rotate.

As described above, the cam lever 416 and handle element 417 rotate about the protrusion 423 which is cylindrical in shape. The rotation of the handle element and cam level about the protrusion (e.g., rather than the screw head 424) mechanically isolates the screw 424 from the rotation of the handle. As such, the screw 424 will not loosen, over tighten or otherwise rotate in response to the rotation of the handle element 417 and cam lever 416.

As a consequence, the torque needed to sufficiently tighten the screw 424 about axis 414 is mechanically de-coupled from the torque about axis 415 associated with the rotation of the handle element 417 and cam lever 416. This can be important as the torque about axis 415 from the rotation of the handle 417 can be larger than the torque needed to tighten the screw 424 (e.g., because of the large radius associated with the handle's rotation). As such, if the aforementioned de-coupling did not exist, rotation of the handle 417 could/would otherwise cause rotation of the screw 424 with possible detrimental effects such as loosening of the screw.

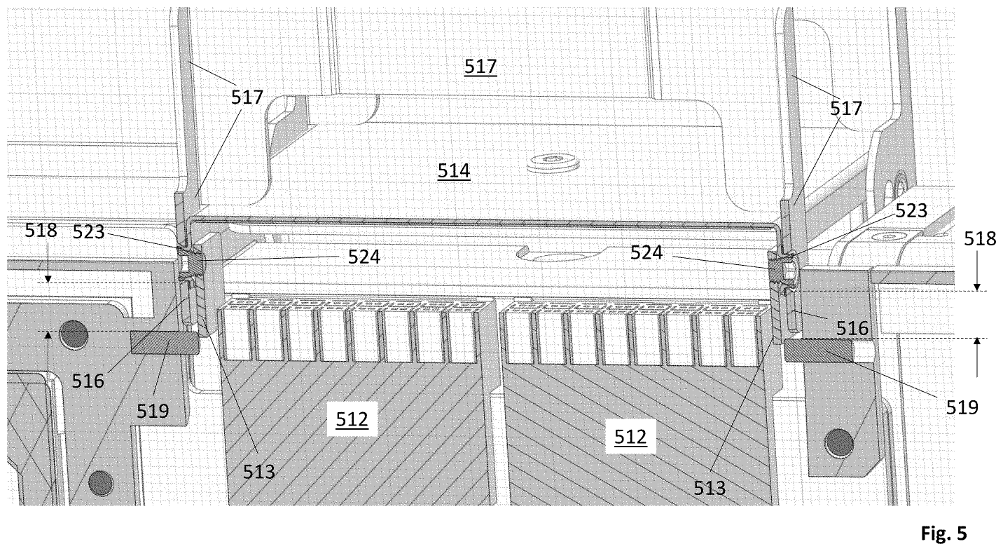

FIG. 5 shows a more detailed cross-section of the connection mechanism from an off angle when the handle element 517 is lifted. Here, each of the edge connector 512, the brace element 513, the cover element 514, the cam lever 516, the handle element 517, the support fixture 519, the protrusion 523 and the screw 524 are depicted. As observed, with the handle element 517 in the lifted position, the cam lever 516 is pressing against the support fixture 519 along its extended length 518 orientation (the cross-section depiction cuts deep enough into the mechanism such that the portions of the cam lever 516 and support structure 519 that make contact with one another have been cut away, as such, there is space between the depicted portion of the cam lever 516 and the depicted portion of the support structure 519).

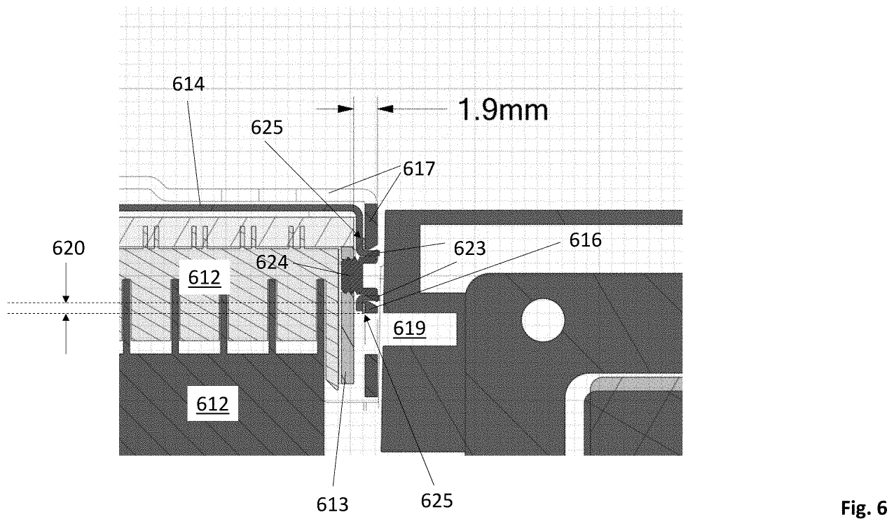

FIG. 6 shows a cross sectional side view of the connection mechanism when the handle element 617 is closed. Here, each of the edge connector 612, the brace element 613, the cover element 614, the cam lever 616, the handle element 617, the protrusion 623 and the screw 624 are depicted. The support fixture is not depicted but it would exist in region 619. As observed, with the handle element 617 in the closed position, the cam lever 616 is pressing against the support fixture along its reduced length 620 orientation.

FIG. 6 also shows the presence of a friction washer 625 between the cover element 614 and the handle element 616 and cam lever 617. The washer 625 is designed to provide sufficient pressure against the cam lever 616 and handle element 617 so that they are rigid/stable in both the lifted and closed positions. That is, because of the pressure applied against the cam lever 616 and handle element 617 by the washer 625, the cam lever 616 and handle element 617 will not loosely rotate to a closed position from a lifted position nor loosely rotate to a lifted position from a closed position.

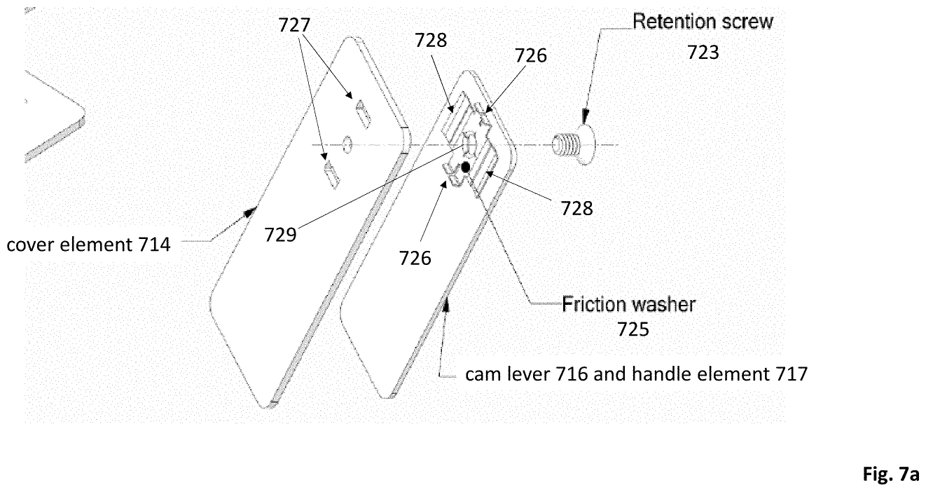

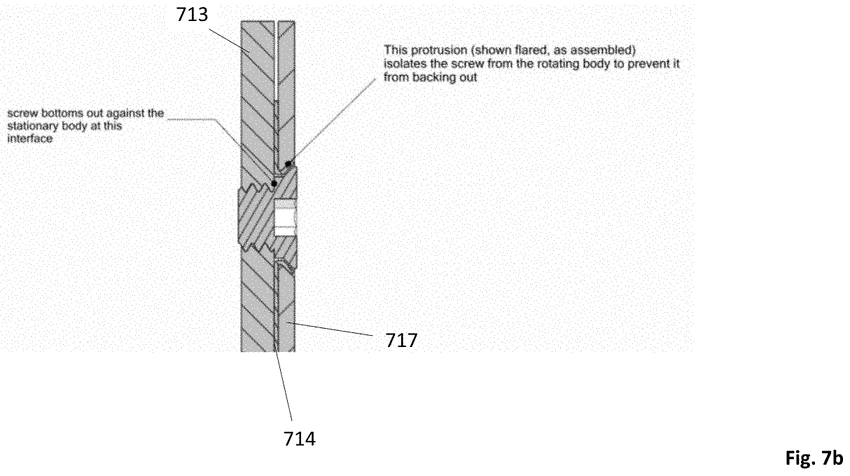

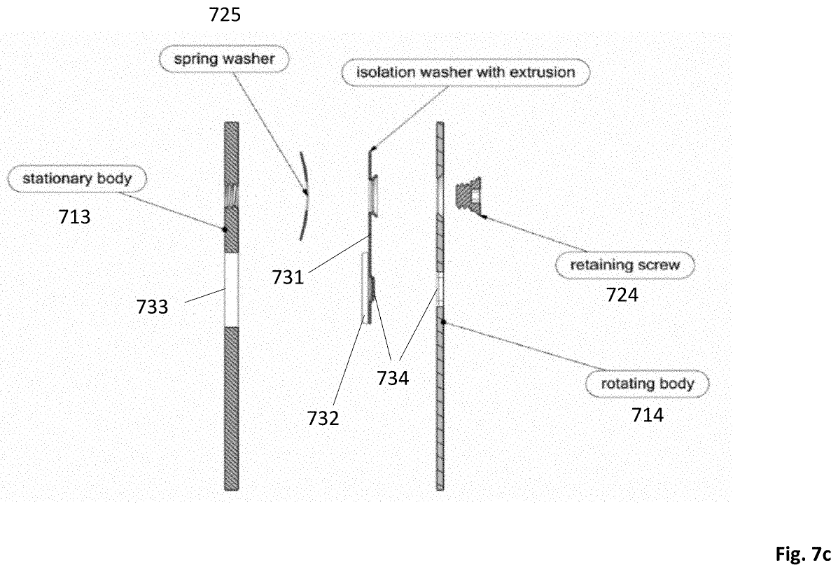

FIG. 7a shows a more detailed view of an embodiment of the friction washer 725. Here, when the cover element 714 and handle and cam lever elements 716, 717 are mated together with the screw 724 with the washer 725 between them, interlocking tabs 726 of the washer 725 fit through corresponding openings 727 in the cover element 714. With the tabs 726 inserted in the openings 727, the washer element 725 will not rotate with the handle and cam lever elements 716, 717 or with the tightening of the screw. The washer 725 includes curved flaps 728 that act like springs to press down on the cover element 714 to provide the pressure against the handle and cam lever elements 716, 717. The washer 725 has a central hole 729 through which the protrusion (not shown) of the cover element 714 is inserted.

FIG. 7b shows a first alternative embodiment where the protrusion in the cover element is flared out to receive the screw head.

FIG. 7c shows a second alternative embodiment where the isolation element, which was the cover in previously described embodiments, is instead implemented as a washer 731 having a flared protrusion to receive the screw 724. In the particular embodiment of FIG. 7c the isolation washer has a tab 732 to fit into an opening 733 in the stationary element 713 so that the isolation washer 731 does not rotate with the rotating element 714. A tongue in groove 734 feature is formed in the isolation washer 731 and the rotating element 714 to help guide the rotating element's rotation. A friction washer 732 can also be inserted between the isolation washer 731 and the stationary element 713.

In various embodiments, regardless if the isolation element is a washer or larger element, the isolation element is thin and cannot be counter bored or countersunk. The screw is within whatever shape the isolation element's extrusion is flared to. If a counter bore exists on the rotating element's hinge axis hole, it will need to take on that shape with the flaring punch tool in a press. Same with a counter sink. That is, the isolation element's protrusion is formed first as an extruded hole of, e.g., cylindrical shape. This extruded hole “protrusion” fits into whatever hole shape the rotating element has and, e.g., is flared into that shape in a press with a punch tool. This permanently attaches the isolation element to the rotating element, still allowing rotation. Neither a counter bore or countersink is also possible if the extrusion is long enough to protrude through the thickness of the rotating element.

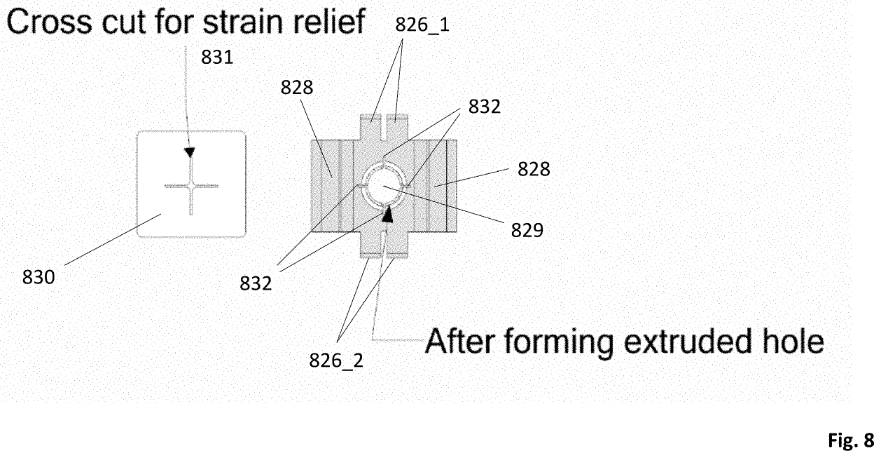

FIG. 8 shows an intermediate stock element 830 from which a friction washer 825 can be created. In various embodiments, the stock element 830 is composed of a hard material in order to effect a high spring constant (e.g., copper, steel, etc.) Here, before forming the interlocking tabs 826 or curved flaps 828, a cross cut 831 is made in the stock element 830 that is centered where the central hole 829 is eventually formed. After formation of the central hole 829, the outer ends 832 of the cross cut 831 remain in the washer 825. Here, the outer ends 832 of the cross cut 831 provide stress relief for the body of the washer 825 as it experiences a shear strain with the high pressure rotation of the handle/cam element against the cover element and/or the tightening of the screw.

Specifically, the upper tabs 726_1 will press against the sides of their respective openings in the cover element in one direction while the lower tabs 726_2 will press against the sides of their respective openings in the cover element in the opposite direction (i.e., because of the pressure the washer will try to rotate with the handle and cam lever). The outer ends 832 of the cross cut 831 allow for some deformation of the radius of the central hole 829 to relieve the washer 825 of the internal stresses it experiences from the resulting shear strain.

In various embodiments, the cross cuts are not required if the washer is made of a softer spring material (e.g., aluminum). For example, if the washer is integrated into another part, such as the cover for a card to card linking interconnect board, the material may be more ductile, and the extrusion can be formed in the sheet metal with no expected cracking.

Although embodiments above have stressed a card to card connector that only connects two cards, in various embodiments, a single connector may connect more than two cards (e.g., three cards, four cards, etc.) Any/all of the connection mechanisms for connecting such a connector to a card may incorporate the teachings provided above.

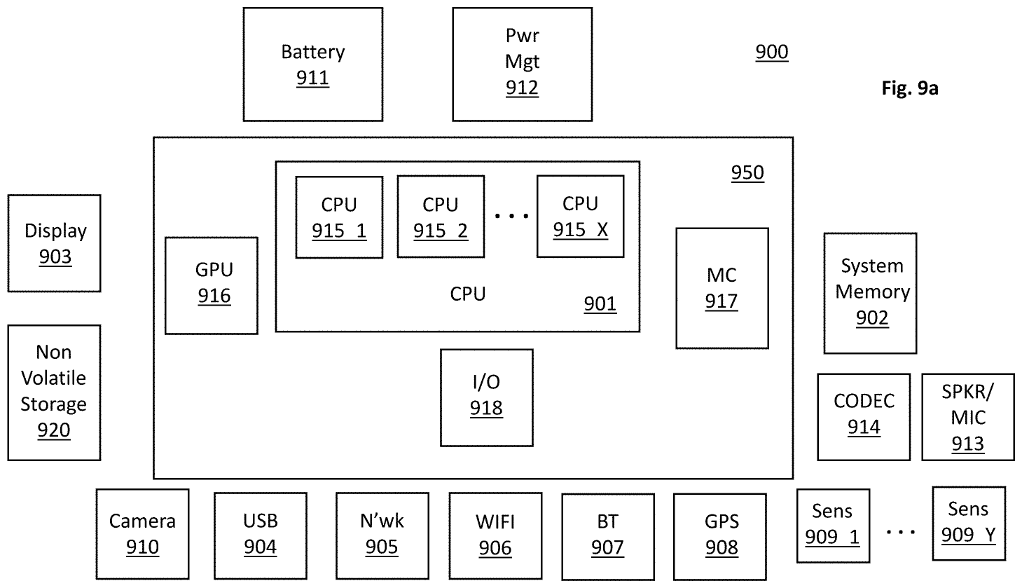

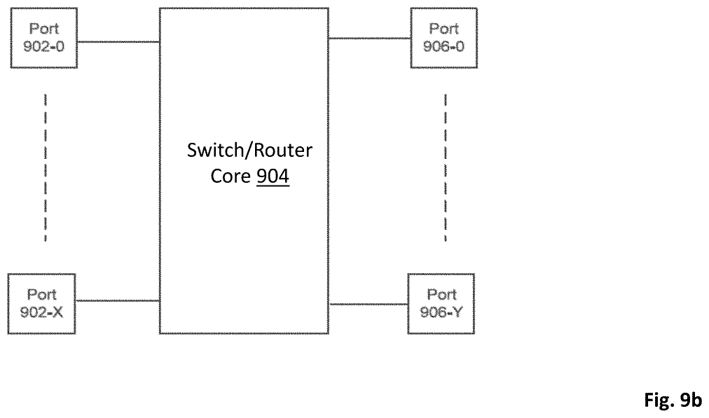

FIG. 9a provides an exemplary depiction of a computing system 900 (e.g., a smartphone, a tablet computer, a laptop computer, a desktop computer, a server computer, etc.). As observed in FIG. 9a, the basic computing system 900 may include a central processing unit 901 (which may include, e.g., a plurality of general purpose processing cores 915_1 through 915_X) and a main memory controller 917 disposed on a multi-core processor or applications processor, system memory 902, a display 903 (e.g., touchscreen, flat-panel), a local wired point-to-point link (e.g., USB) interface 904, various network I/O functions 905 (such as an Ethernet interface and/or cellular modem subsystem), a wireless local area network (e.g., WiFi) interface 906, a wireless point-to-point link (e.g., Bluetooth) interface 907 and a Global Positioning System interface 908, various sensors 909_1 through 909_Y, one or more cameras 910, a battery 911, a power management control unit 912, a speaker and microphone 913 and an audio coder/decoder 914. The CPU 901 or other processor (e.g., GPU) or other high-performance semiconductor chip may include a heat sink assembly having a pre-loaded bolt as described herein and/or a carrier with anti-tile posts as described herein.

An applications processor or multi-core processor 950 can be an SOC that includes one or more general purpose processing cores 915 within its CPU 901, one or more graphical processing units 916, a memory management function 917 (e.g., a memory controller) and an I/O control function or peripheral controller 918. The general-purpose processing cores 915 typically execute the operating system and application software of the computing system. The graphics processing unit 916 typically executes graphics intensive functions to, e.g., generate graphics information that is presented on the display 903. The memory control function 917 interfaces with the system memory 902 to write/read data to/from system memory 902.

Each of the touchscreen display 903, the communication interfaces 904-907, the GPS interface 908, the sensors 909, the camera(s) 910, and the speaker/microphone codec 913, 914 all can be viewed as various forms of I/O (input and/or output) relative to the overall computing system including, where appropriate, an integrated peripheral device as well (e.g., the one or more cameras 910). Depending on implementation, various ones of these I/O components may be integrated on the applications processor/multi-core processor 950 or may be located off the die or outside the package of the applications processor/multi-core processor 950. The computing system also includes non-volatile storage 920 which may be the mass storage component of the system.

FIG. 9b depicts a networking switch or router. Switch/router core 904 can switch/route packets or frames of any format or in accordance with any specification from any port 902-0 to 902-X to any of ports 906-0 to 906-Y (or vice versa). Any of ports 902-0 to 902-X can be connected to a network of one or more interconnected devices. Similarly, any of ports 906-0 to 906-X can be connected to a network of one or more interconnected devices. Switch /router core 904 can decide which port to transfer packets or frames to using a table that maps packet characteristics with an associated output port. In addition, switch/router core 904 can perform packet replication for forwarding of a packet or frame to multiple ports and queuing of packets or frames prior to transfer to an output port.

Here, various components of the computing system of FIG. 9a may be implemented on multiple cards and two or more of such cards may be connected together by a card to card connector having a connection mechanism that incorporates any/all of the teachings provided above. Likewise, various components of the networking switch of FIG. 9b may be implemented on multiple cards (e.g., a switch core card, a network interface card, etc.) and two or more of such cards may be connected together by a card to card connector having a connection mechanism that incorporates any/all of the teachings provided above.

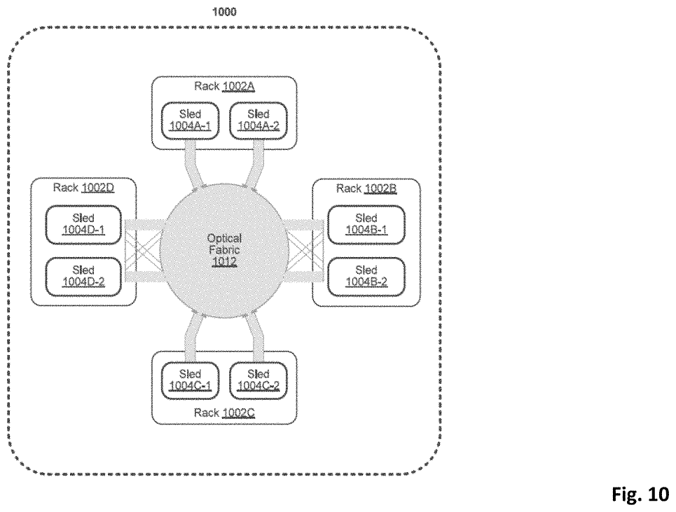

FIG. 10 depicts an example of a data center. Various embodiments can be used in or with the data center of FIG. 10. As shown in FIG. 100, data center 1000 may include an optical fabric 1012. Optical fabric 1012 may generally include a combination of optical signaling media (such as optical cabling) and optical switching infrastructure via which any particular sled in data center 1000 can send signals to (and receive signals from) the other sleds in data center 1000. The signaling connectivity that optical fabric 1012 provides to any given sled may include connectivity both to other sleds in a same rack and sleds in other racks.

A sled may be implemented, e.g., as a card having certain ones of the computing system components described above with respect to FIG. 9. For example, a first type of sled may be composed of CPU elements, a second type of sled may be composed of system memory elements, a third type of sled may be composed of peripheral I/O elements, a fourth type of card may be composed of mass storage elements, etc. Alternatively or in combination a fourth type of sled may approximately correspond to a computing system (e.g., having CPU, system memory, peripheral I/O and mass storage elements or some combination thereof). For example, in various embodiments, each blade comprises a separate computing platform that is configured to perform server-type functions, that is, a “server on a card.” Accordingly, each blade includes components common to conventional servers, including a main printed circuit board (main board) providing internal wiring (i.e., buses) for coupling appropriate integrated circuits (ICs) and other components mounted to the board.

Data center 1000 includes four racks 1002A to 1002D and racks 1002A to 1002D house respective pairs of sleds 1004A-1 and 1004A-2, 1004B-1 and 1004B-2, 1004C-1 and 1004C-2, and 1004D-1 and 1004D-2. Thus, in this example, data center 1000 includes a total of eight sleds. Optical fabric 10012 can provide sled signaling connectivity with one or more of the seven other sleds. For example, via optical fabric 10012, sled 1004A-1 in rack 1002A may possess signaling connectivity with sled 1004A-2 in rack 1002A, as well as the six other sleds 1004B-1, 1004B-2, 1004C-1, 1004C-2, 1004D-1, and 1004D-2 that are distributed among the other racks 1002B, 1002C, and 1002D of data center 1000. The embodiments are not limited to this example. For example, fabric 1012 can provide optical and/or electrical signaling.

It is envisioned that aspects of the embodiments herein can be implemented in various types of computing and networking equipment, such as switches, routers and blade servers such as those employed in a data center and/or server farm environment. Typically, the servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities can typically employ large data centers with a multitude of servers.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” “logic,” “circuit,” or “circuitry.”

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

1. An apparatus, comprising:
a hinge assembly comprising:
i) a stationary element, a first hole formed in the stationary element to receive a retaining screw;
ii) a rotating element that rotates around the retaining screw's axis;
iii) an isolation element between the stationary element and the rotating element located along the retaining screw's axis, the isolation element having a second hole that is aligned with the first hole to receive the retaining screw, the rotating element to be in contact with and rotate about the isolation element when the retaining screw is torqued down to clamp the isolation element and stationary element together.

2. The apparatus of claim 1 wherein the first hole is counter bored.

3. The apparatus of claim 1 wherein the first hole is counter sunk.

4. The apparatus of claim 1 wherein the isolation element is a cover.

5. The apparatus of claim 1 further comprising a spring washer between the rotating element and the isolation element to add friction to the rotating element's rotation.

6. The apparatus of claim 1 wherein the isolation element is a washer.

7. The apparatus of claim 1 wherein the isolation element includes a spring feature to add friction to the rotating element's rotation.

8. The apparatus of claim 1 wherein the isolation element comprises a cut to provide relief from strain induced by the rotating element's rotation.

9. A method, comprising:
forming a hinge assembly by:
coupling an isolation element to a stationary element such that a first hole formed in the stationary element and a second hole formed in the isolation element are aligned;
coupling a rotating element to the isolation element such a third hole formed in the rotating element is aligned with the first hole and the second hole;
inserting a retaining screw through the first hole, the second hole and the third hole and torqueing down the retaining screw to clamp the isolation element and stationary element together such that the rotating element is able to rotate about the retaining screw's axis while the rotating element is in contact with the isolation element.

10. The method of claim 19 wherein the hinge assembly is a component of an electronic card edge connector.
